(19) United States
(12) Patent Application Publication
(10) Pub. No.: US 2026/0288991 A1
(43) Pub. Date: Sep. 24, 2026

(54) DATA PROCESSING METHOD AND APPARATUS, ELECTRONIC DEVICE AND STORAGE MEDIUM

(71) Applicants: BEIJING BOE TECHNOLOGY DEVELOPMENT CO., LTD., Beijing (CN); BOE TECHNOLOGY GROUP CO., LTD., Beijing (CN)

(72) Inventor: Lixiong He, Beijing (CN)

(21) Appl. No.: 19/476,561

(22) PCT Filed: Apr. 16, 2024
(86) PCT No.: PCT/CN2024/087998

§ 371 Date: Oct. 17, 2025

(30) Foreign Application Priority Data
May 31, 2023 (CN) 202310637134.3

(51) Int. Cl. G06F 21/62

(52) U.S. Cl. CPC G06F 21/6218

(57) ABSTRACT

The present disclosure provides a data processing method, a data processing apparatus, an electronic device and a storage medium, which relate to a technical field of databases, cloud platforms and microservices. The data processing method includes: receiving a service request carrying a tenant identification from a first tenant; determining, based on the tenant identification, first tenant information of the first tenant from a tenant table located in a public space of a database; invoking at least one first microservice associated with the first tenant using the first tenant information; and performing a data processing on a data table in a first tenant space associated with the first tenant in the database based on the first tenant information and a data change instruction, in response to acquiring the data change instruction, wherein the data change instruction is generated in a process of invoking the at least one first microservice.

### CROSS REFERENCE TO RELATED APPLICATION(S)

This application is a Section 371 National Stage Application of International Application No. PCT/CN2024/087998, filed on Apr. 16, 2024, entitled “DATA PROCESSING METHOD AND APPARATUS, ELECTRONIC DEVICE AND STORAGE MEDIUM”, which claims priority to Chinese Patent Application No. 202310637134.3 filed on May 31, 2023, the content of which are incorporated herein by reference in their entirety.

### TECHNICAL FIELD

The present disclosure relates to a technical field of databases, cloud platforms and microservices, and in particular to a data processing method, a data processing apparatus, an electronic device and a storage medium.

### BACKGROUND

Multi-tenancy is a type of architectural design, i.e., a Software as a Service (Saas) system running on one server or a group of servers may provide services to multiple tenants with the purpose of allowing the multiple tenants to use the same set of programs in an Internet environment and ensure data isolation among tenants. The focus of a multi-tenant architecture is isolation of data of multiple tenants using the same set of programs. Since data of tenants is stored centrally, achieving security of data depends on whether isolation of the data of tenants may be achieved to prevent the data of tenants from being accidentally or maliciously acquired and tampered with by others.

### SUMMARY

The present disclosure provides a data processing method, a data processing apparatus, an electronic device and a storage medium.

According one aspect of the present disclosure, there is provided a data processing method. The method includes: receiving a service request carrying a tenant identification from a first tenant; determining, based on the tenant identification, first tenant information of the first tenant from a tenant table located in a public space of a database; invoking at least one first microservice associated with the first tenant using the first tenant information; and performing a data processing on a data table in a first tenant space associated with the first tenant in the database based on the first tenant information and a data change instruction, in response to acquiring a data change instruction, in which the data change instruction is generated in a process of invoking the at least one first microservice.

According to another aspect of the present disclosure, there is provided a data processing apparatus. The device includes: a receiving module configured to receive a service request carrying a tenant identification from a first tenant; a first determination module configured to determine, based on the tenant identification, first tenant information of the first tenant from a tenant table located in a public space of a database; an invoking module configured to invoke at least one first microservice associated with the first tenant using the first tenant information; and a processing module configured to perform a data processing on a data table in a first tenant space associated with the first tenant in the database based on the first tenant information and a data change instruction, in response to acquiring a data change instruction, in which the data change instruction is generated in a process of invoking the at least one first microservice.

According to another aspect of the present disclosure, there is provide an electronic device including a memory and a processor, in which the memory stores instructions executable by the processor, and when executed by the processor, the instructions cause the processor to execute and implement the method described above.

According to another aspect of the present disclosure, there is provided a non-transitory computer-readable storage medium storing computer instructions, in which the computer instructions are configured to cause the computer to execute and implement the method described above.

According to another aspect of the present disclosure, there is provided a computer program product including a computer program, in which when executed by a processor, the computer program implements the method described above.

It should be understood that the contents described in this section are not intended to identify key or important features of the embodiments of the present disclosure, nor do they intended to limit the scope of the present disclosure. Other features of the present disclosure will become easily understood from the description below.

### BRIEF DESCRIPTION OF THE DRAWINGS

The accompanying drawings are used to better understand the present solution and do not constitute a limitation of the present disclosure, in which:

FIG. 1 schematically shows an exemplary system architecture to which a data processing method and a data processing apparatus according to an embodiment of the present disclosure may be applied;

FIG. 2 schematically shows a flow diagram of a data processing method according to an embodiment of the present disclosure;

FIG. 3 schematically shows a schematic diagram of a microservice framework in a multi-tenant scenario according to an embodiment of the present disclosure;

FIG. 4 schematically shows a diagram of a tenant creation process according to an embodiment of the present disclosure;

FIG. 5 schematically shows a schematic diagram of a user access process of a first tenant according to an embodiment of the present disclosure;

FIG. 6 schematically shows a schematic diagram of a user access process of a first tenant according to another embodiment of the present disclosure;

FIG. 7 schematically shows a block diagram of a data processing apparatus according to an embodiment of the present disclosure;

FIG. 8 schematically shows a block diagram of an electronic device applicable for implementing a video data processing method according to an embodiment of the present disclosure.

### DETAILED DESCRIPTION OF EMBODIMENTS

Hereinafter, embodiments of the present disclosure will be described with reference to the accompanying drawings. However, it should be understood that these descriptions are only exemplary and are not intended to limit the scope of the present disclosure. In the following detailed description, for ease of explanation, numerous specific details are set forth in order to provide a thorough understanding of the embodiments of the present disclosure. It may be evident, however, that one or more embodiments may be implemented without these specific details. Furthermore, in the following illustration, descriptions of well-known structures and technologies are omitted to avoid unnecessarily obscuring the concepts of the present disclosure.

The terms used herein are for the purpose of describing specific embodiments only and are not intended to limit the present disclosure. The terms “include/comprise”, “contain” and the like used herein indicate the existence of the stated features, steps, operations and/or components, but do not exclude the existence or addition of one or more of other features, steps, operations or components.

All terms (including technical and scientific terms) used herein have meanings as commonly understood by those skilled in the art unless otherwise defined. It should be noted that the terms used herein should be interpreted as having meanings consistent with the context of in the present specification and should not be interpreted in an idealized or overly rigid manner.

In the case of using an expression such as “at least one of A, B and C”, this expression should generally be interpreted in accordance with the meaning of this expression commonly understood by those skilled in the art (for example, “a system having at least one of A, B and C” should include but not be limited to a system having A alone, a system having B alone, a system having C alone, a system having A and B, a system having A and C, a system having B and C, and/or a system having A, B and C). In the case of using an expression such as “at least one of A, B or C”, this expression should generally be interpreted in accordance with the meaning of this expression commonly understood by those skilled in the art (for example, “a system having at least one of A, B or C” should include but not be limited to a system having A alone, a system having B alone, a system having C alone, a system having A and B, a system having A and C, a system having B and C, and/or a system having A, B and C).

In the technical solutions of the present disclosure, the collection, storage, use, processing, transmission, provision, disclosure and application of the data involved (including but not limited to user personal information) all comply with the provisions of relevant laws and regulations, take necessary confidentiality measures, and do not violate public order and good morals.

In the technical solutions of the present disclosure, the authorization or consent of the user is acquired before the user personal information is acquired or collected.

It should be noted that, for operations shown in a flow diagram in the embodiments of the present disclosure, unless it is explicitly stated that there is an execution order of different operations, or there is an execution order of technical implementations for different operations, otherwise, executions of multiple operations may not be prioritized in order, and the multiple operations may also be executed simultaneously.

In related technologies, during implementation of multi-tenant data isolation, one redundant field may be added to each data record, such as a tenant ID. During an operation such as adding, deleting, modifying, or querying a data record, data records that need to be processed may be obtained by filtering according to the tenant ID. Such a method is relatively lightweight and simple in technical implementation, but requires a large amount of change at the code level. Moreover, data of different tenants is not physically or logically isolated, resulting in a low isolation level. Alternatively, based on a containerization technology such as docker or K8s, data of each tenant may be stored in a separate container. Such a method requires relevant technical personnel to have a certain understanding of and familiarity with docker and K8s, and therefore, it is an implementation solution with the highest technical feasibility, the highest isolation level, and the highest operation and maintenance costs.

The embodiments of the present disclosure provide a data processing method, a data processing apparatus, an electronic device, and a storage medium, which may implement a multi-tenant management service in a microservice scenario without affecting the existing microservice framework. The data processing method includes: receiving a service request carrying a tenant identification from a first tenant; determining, based on the tenant identification, first tenant information of the first tenant from a tenant table located in a public space of a database; invoking at least one first microservice associated with the first tenant using the first tenant information; and performing a data processing on a data table in a first tenant space associated with the first tenant in the database based on the first tenant information and a data change instruction, in response to acquiring a data change instruction, in which the data change instruction is generated in a process of invoking the at least one first microservice.

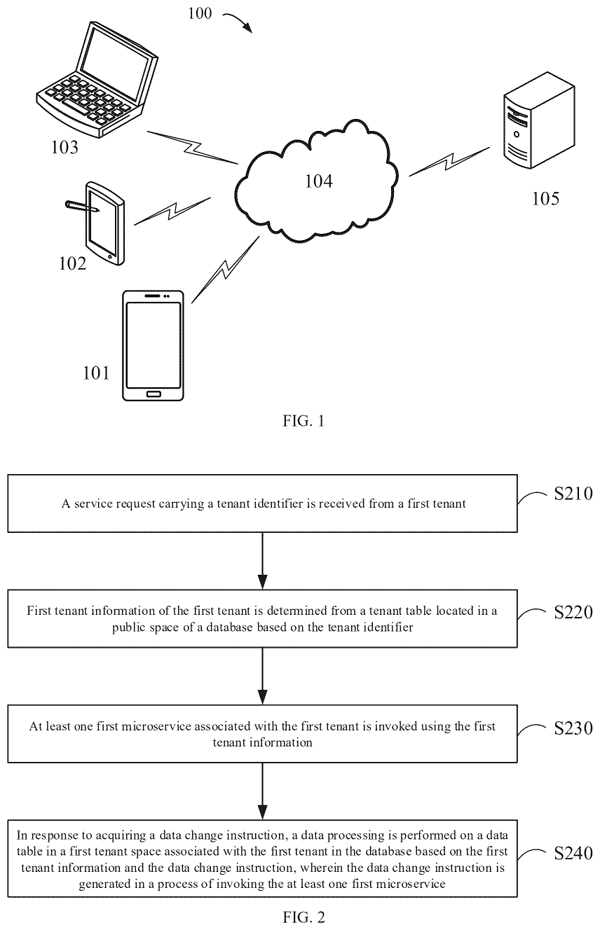

FIG. 1 schematically shows an exemplary system architecture to which a data processing method and a data processing apparatus according to an embodiment of the present disclosure may be applied. It should be noted that FIG. 1 only shows an example of a system architecture to which the embodiments of the present disclosure may be applied, so as to help those skilled in the art understand the technical contents of the present disclosure, but it does not mean that the embodiments of the present disclosure may not be used in other apparatuses, systems, environments or scenarios.

As shown in FIG. 1, the system architecture 100 according to this embodiment may include terminal devices 101, 102 and 103, a network 104 and a server 105.

The terminal devices 101, 102, and 103 may be various electronic devices having a display screen, including but not limited to smart phones, tablet computers, laptop portable computers, desktop computers, etc.

The network 104 may be used for data communication among the terminal devices 101, 102 and 103, or between the terminal devices 101, 102 and 103 and the server 105. The network 104 may include various connection types, such as wired and/or wireless communication links.

The server 102 may be various types of servers that provide various services. For example, the server may be a cloud server, also referred to as a cloud computing server or a cloud host, which is a host product in the cloud computing service system, and overcomes the defects existing in traditional physical hosts and Virtual Private Server (VPS) services, such as difficult management and weak business scalability. The server may also be an edge server. The server may also be a server of a distributed system.

It should be noted that the data processing method provided in the embodiment of the present disclosure may generally be executed by the server 105. Correspondingly, the data processing apparatus provided in the embodiment of the present disclosure may also be arranged in the server 105.

For example, a user may access a tenant service provided by the server 105 through a browser application on any one of the terminal devices 101, 102 and 103 (such as the terminal device 101). By accessing the tenant service, the user may invoke a microservice corresponding to the tenant. In a process of invoking the microservice by the user, an input operation of the user on the terminal device 101 may be sent to the server 105 via the network 104. The server 105 may intercept a data change operation in the input operation, rewrite an SQL statement contained in the data change operation, and then execute the SQL statement to perform a data change processing on a data table in a tenant space of a corresponding tenant in the database.

It should be understood that the numbers of the terminal devices, the network and the server in FIG. 1 are merely illustrative. Depending on the implementation requirements, there may be any number of terminal devices, networks, and servers.

FIG. 2 schematically shows a flow diagram of a data processing method according to an embodiment of the present disclosure.

As shown in FIG. 2, the data processing method may include operations S210 to S240.

In operation S210, a service request carrying a tenant identification is received from a first tenant.

In operation S220, first tenant information of the first tenant is determined from a tenant table located in a public space of a database based on the tenant identification.

In operation S230, at least one first microservice associated with the first tenant is invoked using the first tenant information.

In operation S240, in response to acquiring a data change instruction, a data processing is performed on a data table in a first tenant space associated with the first tenant in the database based on the first tenant information and the data change instruction. The data change instruction is generated in a process of invoking the at least one first microservice.

According to an embodiment of the present disclosure, a tenant may be represented as a set of accessible resources in each service. Such a set of resource set may be used by plurality of users, and the users may access computing management resources through tenants. The first tenant may be any tenant in the microservice framework. The user may use one or more microservices in the microservice framework through the first tenant.

According to an embodiment of the present disclosure, the service request may be an access request initiated by a user of the first tenant. That is, after logging in through the first tenant, the user may initiate a service request to a resource service to access tenant data of the first tenant.

According to an embodiment of the present disclosure, the tenant identification of the first tenant may be string information used to uniquely indicate the first tenant. The tenant identification may be a random number consisting of at least one of numbers, uppercase letters, and lowercase letters. The tenant identification may be of a fixed length.

According to an embodiment of the present disclosure, the tenant table may be a data table storing information of each tenant, such as tenant identification, tenant name, and tenant creation time. Data structure of the tenant table may be shown in TABLE 1. The tenant table may record information such as field name, data type, length, default value, and description of each information item such as tenant identification, tenant name, and tenant creation time.

TABLE 1

| Field name | Data type | Length | Default value | Description |
|---|---|---|---|---|
| id | int8 | | | Tenant identification |
| tenant_name | varchar | 60 | | Tenant name |
| db_schema | varchar | 60 | | Tenant data space |
| create_time | timestamp | 29 | | Creation time |
| update_time | timestamp | 29 | | Update time |
| update_by | varchar | 32 | “::chara | Update user |

According to an embodiment of the present disclosure, the first tenant information may at least include information of the tenant data space associated with the first tenant, such as the name of the tenant data space.

According to an embodiment of the present disclosure, the public space of the database may be a schema named public in the database.

According to an embodiment of the present disclosure, different tenants may use different microservices. The at least one first microservice associated with the first tenant may include a microservice that may be invoked by the user through the first tenant. The at least one first microservice associated with the first tenant may be configured in the tenant table during creation or update of the first tenant.

According to an embodiment of the present disclosure, the first tenant and the first microservice may communicate with each other through a gateway server. The gateway server may be provided with an interceptor for the first tenant. When the first tenant performs a data change, the interceptor may perform an interception to obtain a data change instruction.

According to an embodiment of the present disclosure, the data change instruction may be generated in a process of invoking the at least one first microservice associated with the first tenant by the user. The data change instruction may include a structured query statement, i.e., an SQL statement, generated based on a user operation.

According to an embodiment of the present disclosure, the first tenant space associated with the first tenant may be a schema associated with the first tenant in the database. The schema may be named using the tenant identification of the first tenant or the tenant name of the first tenant, which is not limited here.

According to an embodiment of the present disclosure, performing a data processing on the data table in the first tenant space may be performing a data update on the data table in the first tenant space based on an SQL statement included in the data change instruction.

According to an embodiment of the present disclosure, the user may initiate a service request through the first tenant. After receiving the service request, the gateway server may determine first tenant information of the first tenant from the tenant table, and invoke the at least one first microservice associated with the first tenant using the first tenant information. For the data change instruction generated in the process of invoking the first microservice by the user, the data change instruction may be modified using the first tenant information, and data processing may be performed on the data table in the first tenant space using the modified data change instruction. In this way, data isolation may be achieved in the multi-tenant scenario based on the microservice framework, thereby improving the data isolation effect.

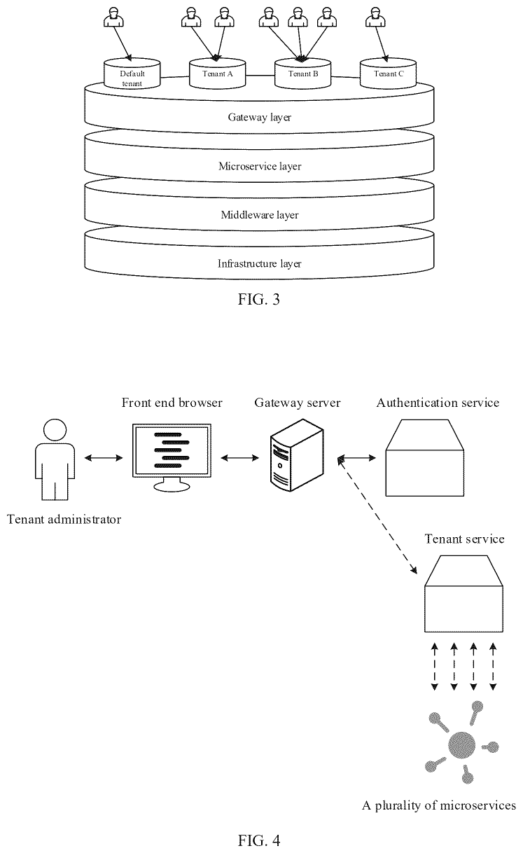

The data processing method shown in FIG. 2 will be further described in conjunction with the specific embodiments with reference to FIG. 3 to FIG. 6.

FIG. 3 schematically shows a schematic diagram of a microservice framework in a multi-tenant scenario according to an embodiment of the present disclosure.

As shown in FIG. 3, the microservice framework may be based on Liquibase and PostgreSQL database.

According to an embodiment of the present disclosure, the microservice framework may include, from the bottom up, an infrastructure layer, a middleware layer, a microservice layer, a gateway layer, and a plurality of tenants. The infrastructure layer may include infrastructures, such as servers, memories and networks. The middleware layer may include middleware, such as caches and message queues. The microservice layer may include various microservices that may provide services to the outside. The gateway layer may provide accesses, such as access control, information forwarding and reverse proxy.

According to an embodiment of the present disclosure, each tenant may support register and access by a plurality of users. For example, user 1 and user 2 may both access the microservice framework through tenant A.

According to an embodiment of the present disclosure, each tenant may have a permission to invoke one or more of the plurality of microservices. Each tenant service may correspond to a database instance in the PostgreSQL database, i.e., a database space in the PostgreSQL database. The name of the database space of the PostgreSQL database may be used as the tenant identification of the corresponding tenant. The PostgreSQL database may include one public space, and data tables in the database space corresponding to various tenants may have the same database table result as the data table in the public space.

According to an embodiment of the present disclosure, the plurality of tenants may at least include one default tenant. The default tenant may correspond to a user referred to as a tenant administrator, and the tenant administrator may perform management such as creation and deletion of tenants.

FIG. 4 schematically shows a diagram of a tenant creation process according to an embodiment of the present disclosure.

As shown in FIG. 4, when creating a tenant, for example, when creating a second tenant, the tenant administrator may submit basic information of the tenant needs to be created through the tenant service. Specifically, the tenant administrator may initiate a tenant creation request to the gateway server based on second tenant information.

According to an embodiment of the present disclosure, in response to a tenant creation request for a second tenant, the gateway server may create a second tenant space in the database based on the second tenant information carried in the tenant creation request.

According to an embodiment of the present disclosure, specifically, in response to the tenant creation request, the gateway server may generate a random string of a preset length. The random string may be a string containing numbers, uppercase and lowercase English letters, which may avoid conflicts with Chinese characters and special characters such as slashes and underscores.

According to an embodiment of the present disclosure, the gateway server may generate an initial tenant space in the database by using the random string as a schema space name, i.e., create a schema of the tenant in the PostgreSQL database.

According to an embodiment of the present disclosure, the gateway server may create a plurality of initial data tables, i.e., initialize table structures, in the initial tenant space based on the second tenant information.

According to an embodiment of the present disclosure, the table structures may be initialized by using the microservices needed by the tenants and the data of the microservices as an isolation strategy. Specifically, at least one second microservice associated with the second tenant may be determined based on the second tenant information. A plurality of initial data tables are created in the initial tenant space based on a data table associated with each of the at least one second microservice.

According to an embodiment of the present disclosure, by initializing the table structures using the microservices needed by the tenants and the data of the microservices as an isolation strategy, different tenants may have different microservices and different database spaces to isolate the generated data, thereby achieving data isolation under the microservice framework. Additionally, when creating a tenant, an on-demand creation may be achieved based on the needs of the tenant for microservices, which may reduce the use of database server resources and speed up the initialization of the database table structures in the tenant space.

According to an embodiment of the present disclosure, a plurality of initial data tables are initialized using the plurality of data tables included in the public space of the database to obtain a second tenant space, i.e., table data is initialized.

According to an embodiment of the present disclosure, in the initialization of the table data, a plurality of target data tables may be determined from the plurality of data tables included in the public space of the database based on the plurality of initial data tables. The target data table may correspond to the initial data table. Data synchronization of the plurality of initial data tables may be performed using the plurality of target data tables to initialize the plurality of initial data tables, so as to obtain the second tenant space.

According to an embodiment of the present disclosure, the initialization of the table structures and the the table data may be implemented through Liquibase, which will not be repeated here. Alternatively, initialization of the table structures may be implemented using any data table generation method, which is not limited here. Initialization of the table data by any data synchronization method, which is not limited here.

According to the embodiment of the present disclosure, in a microservice scenario, data isolation is a very important link. The scalability and hot deployment among microservices all involve data isolation at the bottom layer. Therefore, for tenants, different tenants may use different services. Accordingly, when creating a tenant, it is not necessary to create all services for the tenant. That is, creation is performed on demand and dynamically, which may reduce the use of database server resources, speed up the initialization of the database table structure of the user schema, achieve a rapid response of tenant services in the microservice scenario, and improve user experience.

According to an embodiment of the present disclosure, when a service request is received from the first tenant, an access authentication may be performed on the service request to determine an access authority of the user.

According to an embodiment of the present disclosure, the service request initiated by the user through the first tenant may carry user credential information. The user credential information may be, for example, information such as the login account name and password of the user.

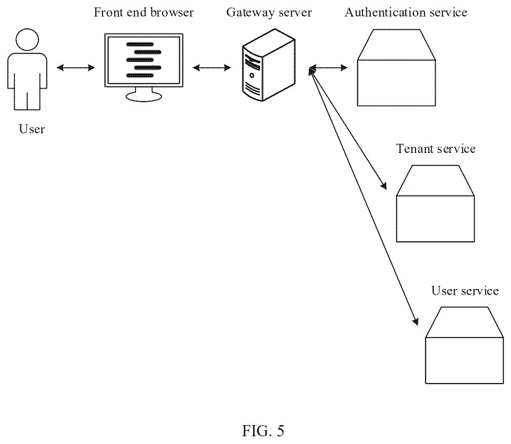

FIG. 5 schematically shows a schematic diagram of a user access process of a first tenant according to an embodiment of the present disclosure.

As shown in FIG. 5, a user belonging to the first tenant may input a tenant identification and user credential information in a front end browser, so that the front end browser initiates a service request to the gateway server based on the tenant identification and the user credential information.

According to an embodiment of the present disclosure, in response to receiving the service request, the gateway server may perform an access authentication on the user credential information to obtain an authentication result. Specifically, the gateway server may invoke an authentication service to obtain an information list of users registered in the first tenant, and perform matching with the information contained in the information list using the user credential information to determine whether the user credential information exists in the information list, thereby obtaining an authentication result of whether the user has passed the authentication.

According to an embodiment of the present disclosure, in a case that the authentication result indicates a successful authentication, the gateway server may determine first tenant information of the first tenant from the tenant table based on the tenant identification. Specifically, the gateway server may invoke a tenant service to perform an authentication on the first tenant based on the tenant identification, and after determining that the first tenant has passed the authentication, acquire a tenant space information table using the tenant service. Authentication of the first tenant may include verifying whether the first tenant has been created in the microservice framework. A tenant information table may be maintained in the tenant service, and the tenant identification may be matched with a plurality of identification information included in the tenant information table. The authentication result of the first tenant may be obtained based on the matching result. The tenant space information table may include a tenant space associated with each tenant, i.e., a tenant schema.

According to an embodiment of the present disclosure, after acquiring the first tenant information of the first tenant, the gateway server may invoke the user service to invoke the at least one first microservice associated with the first tenant. Specifically, the gateway server may determine an access path for each of the at least one first microservice based on the first tenant information, and respectively forward the service request to the at least one first microservice based on the access path for each of the at least one first microservice to invoke the at least one first microservice.

According to an embodiment of the present disclosure, when providing services to different tenants, the same microservice may provide different access paths. Different access paths may be decoded to point to the same address. For example, the access path provided by microservice A to tenant 1 is A1.com, and the access path provided by microservice A to tenant 2 is A2.com. The two access paths may point to the same address A.com. That is, when tenant 1 invokes microservice A using A1.com, and when tenant 2 invokes microservice A using A2.com, they both finally point to address A.com.

According to an embodiment of the present disclosure, the user credential information may also include other information that may verify the access behavior of the user, such as a login token. After logging in for the first time and passing the verification, the user may acquire a login token based on information such as the login account name and password of the user, so that authentications of the user and the tenant may be achieved using the login token in a subsequent access to the microservice.

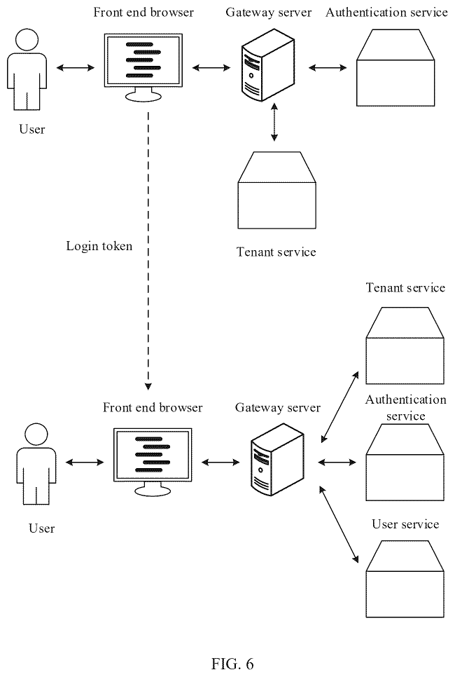

FIG. 6 schematically shows a schematic diagram of a user access process of a first tenant according to another embodiment of the present disclosure.

As shown in FIG. 6, the user access process of the first tenant may include a login process and an access process.

According to an embodiment of the present disclosure, in the login process, the user may enter user information, such as the tenant identification, login account name and password in the front end browser, so that the front end browser may initiate a user login request to the gateway server based on the user information, such as the tenant identification, login account name and password.

According to an embodiment of the present disclosure, in response to receiving a user login request from the first tenant, the gateway server may perform a login verification on the user information carried in the user login request to obtain a verification result. Specifically, the gateway server may invoke an authentication service and verify the user information such as the login account name and password using the authentication service to obtain the verification result indicating whether the login verification is successful.

According to an embodiment of the present disclosure, in a case that the verification result indicates a successful login verification, the tenant service may generate user credential information based on the user information. Specifically, the data table associated with the user information maintained in the tenant service may be preset with user credential information associated with the user information, i.e., a login token. The tenant service may acquire a corresponding login token from the data table based on the user information and return it to the gateway server.

According to an embodiment of the present disclosure, the gateway server may return the user credential information to the first tenant, i.e., return the login token to the front end browser.

According to an embodiment of the present disclosure, as an optional implementation, in the login process, the gateway server may also invoke the tenant service to determine the first tenant information of the first tenant from the tenant table by means of the tenant identification.

According to an embodiment of the present disclosure, in the access process, the user may directly click a quick access button of the front end browser, and the front end browser may generate a service request based on the tenant identification and login token, and send the service request to the gateway service.

According to an embodiment of the present disclosure, when the service request invokes a tenant service or an authentication service to perform authentication on a tenant or a user, the authentication may be achieved based on the login token, and after the authentication is passed, the first microservice may be invoked based on the tenant identification, which will not be repeated here.

According to an embodiment of the present disclosure, when the microservice is invoked by the user through the first tenant, an interceptor for the tenant space of the first tenant may be generated in the gateway server. The interceptor may be used to intercept and acquire a data change instruction when a data change occurs. In response to acquiring the data change instruction, the gateway server may concatenate the first tenant information with the data change instruction to obtain a target data change instruction. The first tenant space is determined from the database based on the space name included in the first tenant information. The target data change instruction is executed to perform a data processing on the data table in the first tenant space. The data processing may include but is not limited to processing such as addition, deletion, and modification of data.

For example, a connection may be established to acquire each SQL statement to be executed and parse the SQL statement into a Java object. Schema information of the user, i.e., the first tenant information, is added in the table name signature in the SQL statement. The modified SQL statement may then be further executed to perform a data change processing on the data table in the first tenant space.

According to an embodiment of the present disclosure, during execution of an SQL query, standard SQL statements are intercepted by the interceptor. In order to improve the SQL query efficiency, tenant information and user information may be cached first to ensure that the user may quickly and stably acquire the required information in the access process. At the same time, since in the microservice environment, the process from an initiation of a request by the user to an end of a response involves associated communications among a plurality of services, the tenant information may be updated in real time in the cache and then synchronized to the database through asynchronous refresh. In order to facilitate quick processing on SQLs by the interceptor, backend developers may avoid using SQLs that are complex and difficult to be maintained and updated, such as multi-table joins and nested queries, in the process of developing microservices, so as to reduce the maintenance cost for the developers and allow a quick development.

According to an embodiment of the present disclosure, in the microservice scenario, for database table management operations such as update and addition of microservices, corresponding version information record may be stored in liquibase, so as to facilitate rollback operations in case of system abnormalities.

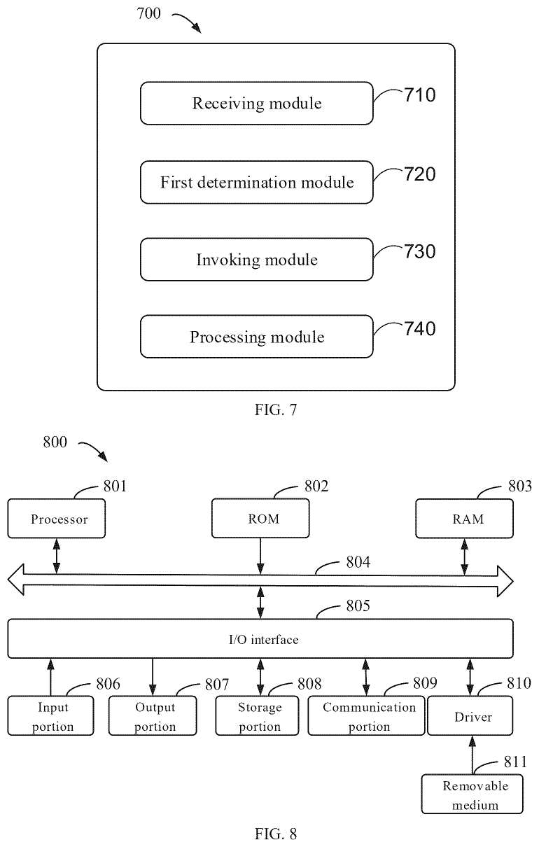

FIG. 7 schematically shows a block diagram of a data processing apparatus according to an embodiment of the present disclosure

As shown in FIG. 7, a data processing apparatus 700 may include a receiving module 710, a first determination module 720, an invoking module 730 and a processing module 740.

The receiving module 710 is used to receive a service request carrying a tenant identification from a first tenant.

The first determination module 720 is used to determine, based on the tenant identification, first tenant information of the first tenant from a tenant table located in a public space of a database.

The invoking module 730 is used to invoke at least one first microservice associated with the first tenant using the first tenant information.

The processing module 740 is used to perform a data processing on a data table in a first tenant space associated with the first tenant in the database based on the first tenant information and a data change instruction, in response to acquiring a data change instruction, in which the data change instruction is generated in a process of invoking the at least one first microservice.

According to an embodiment of the present disclosure, the processing module 740 includes a first processing unit, a second processing unit and a third processing unit.

The first processing unit is used to concatenate, in response to acquiring the data change instruction, the first tenant information with the data change instruction to obtain a target data change instruction.

The second processing unit is used to determine the first tenant space from the database based on a space name included in the first tenant information.

The third processing unit is used to execute the target data change instruction to perform the data processing on the data table in the first tenant space.

According to an embodiment of the present disclosure, the invoking module includes a first invoking unit and a second invoking unit.

The first invoking unit is used to determine an access path for each of the at least one first microservice based on the first tenant information.

The second invoking unit is used to forward, based on the access path for each of the at least one first microservice, the service request to the at least one first microservice respectively to invoke the at least one first microservice.

According to an embodiment of the present disclosure, the service request further carries user credential information.

According to an embodiment of the present disclosure, the data processing apparatus 700 further includes an authentication module and a second determination module.

The authentication module is used to perform, in response to receiving the service request, an access authentication on the user credential information to obtain an authentication result.

The second determination module is used to, in a case that the authentication result indicates a successful authentication, determine the first tenant information of the first tenant from the tenant table based on the tenant identification.

According to an embodiment of the present disclosure, the data processing apparatus 700 further includes a verification module, a generation module and a sending module.

The verification module is used to perform, in response to receiving a user login request from the first tenant, a login verification on user information carried in the user login request to obtain a verification result.

The generation module is used to, in a case that the verification result indicates a successful login verification, generate the user credential information based on the user information.

The sending module is used to return the user credential information to the first tenant.

According to an embodiment of the present disclosure, the data processing apparatus 700 further includes a creation module.

The creation module is used to create, in response to a tenant creation request for a second tenant, a second tenant space in the database based on second tenant information carried in the tenant creation request.

According to an embodiment of the present disclosure, the creation module includes a first creation unit, a second creation unit, a third creation unit and a fourth creation unit.

The first creation unit is used to generate, in response to the tenant creation request, a random string of a preset length.

The second creation unit is used to generate an initial tenant space in the database by using the random string as a schema space name.

The third creation unit is used to create a plurality of initial data tables in the initial tenant space based on the second tenant information.

The fourth creation unit is used to initialize the plurality of initial data tables using a plurality of data tables included in the public space of the database to obtain the second tenant space.

According to an embodiment of the present disclosure, the third creation unit includes a first creation subunit and a second creation subunit.

The first creation subunit is used to determine at least one second microservice associated with the second tenant based on the second tenant information.

The second creation subunit is used to create the plurality of initial data tables in the initial tenant space based on a data table associated with each of the at least one second microservice.

According to an embodiment of the present disclosure, the fourth creation unit includes a third creation subunit and a fourth creation subunit.

The third creation subunit is used to determine a plurality of target data tables from the plurality of data tables included in the public space of the database based on the plurality of initial data tables, in which the target data tables correspond to the initial data tables.

The fourth creation subunit is used to perform a data synchronization on the plurality of initial data tables using the plurality of target data tables to initialize the plurality of initial data tables, so as to obtain the second tenant space.

Any number of modules, sub-modules, units and sub-units according to the embodiments of the present disclosure or at least part of the functions of any number of them may be implemented in one module. Any one or more of modules, sub-modules, units, and sub-units according to the embodiments of the present disclosure may be split into a plurality of modules for implementation. Any one or more of modules, sub-modules, units, and sub-units according to the embodiments of the present disclosure may be at least partially implemented as a hardware circuit, such as a Field Programmable Gate Array (FPGA), a Programmable Logic Array (PLA), a system on chip, a system on substrate, a system on package or an Application Specific Integrated Circuit (ASIC), or may be implemented by hardware or firmware in any other reasonable manner of integrating or packaging a circuit, or may be implemented by any one or by an appropriate combination of any of software, hardware, and firmware. Alternatively, one or more of the modules, sub-modules, units, and sub-units according to the embodiments of the present disclosure may be at least partially implemented as a computer program module. The computer program module may perform corresponding functions when executed.

For example, any number of the receiving module 710, the first determination module 720, the invoking module 730 and the processing module 740 may be combined into one module/unit/sub-unit for implementation, or any one module/unit/sub-unit may be split into a plurality of modules/units/sub-units. Alternatively, at least part of the functions of one or more modules/units/sub-units of these modules/units/sub-units may be combined with at least part of the functions of other modules/units/sub-units and implemented in one module/unit/sub-unit. According to the embodiments of the present disclosure, at least one of the receiving module 710, the first determination module 720, the invoking module 730 and the processing module 740 may be at least partially implemented as a hardware circuit, such as a Field Programmable Gate Array (FPGA), a Programmable Logic Array (PLA), a system on chip, a system on substrate, a system on package or an Application Specific Integrated Circuit (ASIC), or may be implemented by hardware or firmware in any other reasonable manner of integrating or packaging a circuit, or may be implemented by any one or by an appropriate combination of any of software, hardware and firmware. Alternatively, at least one of the receiving module 710, the first determination module 720, the invoking module 730 and the processing module 740 may be at least partially implemented as a computer program module. The computer program module may perform corresponding functions when executed.

It should be noted that the data processing apparatus in the embodiments of the present disclosure corresponds to the data processing method in the embodiments of the present disclosure. Reference may be made to the data processing method for the description of the data processing apparatus, which will not be repeated here.

FIG. 8 schematically shows a block diagram of an electronic device applicable for implementing a video data processing method according to an embodiment of the present disclosure. The electronic device shown in FIG. 8 is only an example, and should not bring any limitation to the function and application scope of the embodiments of the present disclosure.

As shown in FIG. 8, the electronic device 800 according to an embodiment of the present disclosure includes a processor 801, which may execute various appropriate actions and processing according to a program stored in a read-only memory (ROM) 802 or a program loaded from a storage portion 808 to a random access memory (RAM) 803. The processor 801 may include, for example, a general-purpose microprocessor (e.g., a CPU), an instruction set processor and/or a related chipset and/or a dedicated microprocessor (e.g., an application-specific integrated circuit (ASIC)). The processor 801 may also include an onboard memory for caching purposes. The processor 801 may also include a single processing unit or a plurality of processing units for executing different actions of the method flow according to the embodiments of the present disclosure.

In the RAM 803, various programs and data necessary for the operation of the electronic device 800 are stored. The processor 801, the ROM 802, and the RAM 803 are connected to one another via a bus 804. The processor 801 executes various operations of the method flow according to an embodiment of the present disclosure by executing programs in the ROM 802 and/or the RAM 803. It should be noted that the programs may also be stored in one or more memories other than the ROM 802 and the RAM 803. The processor 801 may also execute various operations of the method flow according to the embodiments of the present disclosure by executing programs stored in the one or more memories.

According to an embodiment of the present disclosure, the electronic device 800 may further include an input/output (I/O) interface 805, which is also connected to the bus 804. The electronic device 800 may also include one or more of the following components connected to the I/O interface 805: an input portion 806 including a keyboard, a mouse and the like; an output portion 807 including a cathode ray tube (CRT), a liquid crystal display (LCD), a speaker and the like; a storage portion 808 including a hard disk and the like; and a communication portion 809 including a network interface card such as a LAN card, a modem and the like. The communication portion 809 executes a communication processing via a network such as the Internet. A drive 810 is also connected to the I/O interface 805 as needed. A removable medium 811, such as a magnetic disk, an optical disk, a magneto-optical disk, a semiconductor memory, or the like, is installed on the drive 810 as needed, so that a computer program read therefrom is installed into the storage portion 808 as needed.

The present disclosure also provides a non-transitory computer-readable storage medium. The computer-readable storage medium may be included in the apparatus/device/system described in the above embodiments, or may exist independently without being assembled into the apparatus/device/system. The above computer-readable storage medium carries one or more programs, and when the one or more programs are executed, the method according to the embodiments of the present disclosure is implemented.

According to an embodiment of the present disclosure, the computer-readable storage medium may be a non-volatile computer-readable storage medium, for example, including but not limited to: a portable computer disk, a hard disk, a random access memory (RAM), a read-only memory (ROM), an erasable programmable read-only memory (EPROM or a flash memory), a portable compact disk read-only memory (CD-ROM), an optical storage device, a magnetic storage device, or any suitable combination of the above. In the present disclosure, the computer-readable storage medium may be any tangible medium containing or storing a program, and the program may be used by or in connection with an instruction execution system, a device, or a component. For example, according to the embodiments of the present disclosure, the computer-readable storage medium may include the ROM 802 and/or the RAM 803 described above and/or one or more memories other than the ROM 802 and the RAM 803.

An embodiment of the present disclosure also includes a computer program product including a computer program. The computer program contains program codes for executing the method shown in the flow diagram. When the computer program product runs in a computer system, the program codes are used to cause the computer system to implement the method provided by the embodiments of the present disclosure.

When executed by the processor 801, the computer program executes the above functions defined in the system/device of the embodiments of the present disclosure. According to the embodiments of the present disclosure, the system, the device, the modules, the units, etc. described above may be implemented by computer program modules.

In one embodiment, the computer program may be stored in a tangible storage medium such as an optical storage device or a magnetic storage device. In another embodiment, the computer program may also be transmitted and distributed in the form of a signal on a network medium, downloaded and installed through the communication portion 809, and/or installed from the removable medium 811. The program codes included in the computer program may be transmitted using any appropriate network medium, including but not limited to a wireless manner and a wired manner, or any appropriate combination of the above.

In such an embodiment, the computer program may be downloaded and installed from a network through the communication portion 809, and/or installed from the removable medium 811. When executed by the processor 801, the computer program executes the above functions defined in the system of the embodiments of the present disclosure. According to the embodiments of the present disclosure, the system, the apparatus, the device, the modules, the units, etc. described above may be implemented by computer program modules.

According to an embodiment of the present disclosure, program codes for executing the computer programs provided by the embodiments of the present disclosure may be written in any combination of one or more programming languages. Specifically, these computer programs may be implemented using high-level procedural and/or object-oriented programming languages, and/or assembly/machine languages. Programming languages include, but are not limited to, Java, C++, Python, “C” language or similar programming languages. The program codes may be executed entirely on a user computing device, partly on a use computing device, partly on a remote computing device, or entirely on a remote computing device or server. In a case where a remote computing device is involved, the remote computing device may be connected to the user computing device via any type of network, including a local area network (LAN) or a wide area network (WAN), or may be connected to an external computing device (for example, via the Internet using an Internet service provider).

The flow diagrams and block diagrams in the accompanying drawings illustrate system architectures, functions, and operations that may be implemented by the system, the method, and the computer program product according to various embodiments of the present disclosure. In this regard, each box in the flow diagram or block diagram may represent a module, a program segment, or a portion of a code. The module, the program segment, or the portion of a code contains one or more executable instructions for implementing the specified logical functions. It should also be noted that, in some alternative implementations, the functions noted in the blocks may occur in an order different from the order noted in the drawings. For example, two blocks shown in succession may, in fact, be executed substantially concurrently, or they may sometimes be executed in a reverse order, depending upon the functions involved. It should also be noted that each box in the block diagram or flow diagram and combinations of boxes in the block diagram or flow diagram may be implemented by a dedicated hardware-based system that executes the specified functions or operations, or may be implemented by a combination of dedicated hardware and computer instructions.

Those skilled in the art may understand that various combinations and conjunctions of the features described in various embodiments and/or claims of the present disclosure may be made, even if such combinations or conjunctions are not explicitly described in the present disclosure. In particular, various combinations and conjunctions of the features described in various embodiments and/or claims of the present disclosure may be made without departing from the spirit and teachings of the present disclosure. All such combinations and/or conjunctions fall within the scope of the present disclosure.

The embodiments of the present disclosure are described above. However, these embodiments are for illustrative purposes only and are not intended to limit the scope of the present disclosure. Although various embodiments are described above separately, this does not mean that measures in various embodiments may not be used advantageously in combination. The scope of the present disclosure is defined by the appended claims and the equivalents thereof. Without departing from the scope of the present disclosure, those skilled in the art may make various substitutions and modifications, and all these substitutions and modifications should fall within the scope of the present disclosure.

1. A data processing method, comprising:
receiving a service request carrying a tenant identification from a first tenant;
determining, based on the tenant identification, first tenant information of the first tenant from a tenant table located in a public space of a database;
invoking at least one first microservice associated with the first tenant using the first tenant information; and
performing a data processing on a data table in a first tenant space associated with the first tenant in the database based on the first tenant information and a data change instruction, in response to acquiring the data change instruction, wherein the data change instruction is generated in a process of invoking the at least one first microservice.

2. The method according to claim 1, wherein the performing a data processing on a data table in a first tenant space associated with the first tenant in the database based on the first tenant information and a data change instruction, in response to acquiring the data change instruction comprises:
concatenating, in response to acquiring the data change instruction, the first tenant information with the data change instruction to obtain a target data change instruction;
determining the first tenant space from the database based on a space name comprised in the first tenant information; and
executing the target data change instruction to perform the data processing on the data table in the first tenant space.

3. The method according to claim 1, wherein the invoking at least one first microservice associated with the first tenant using the first tenant information comprises:
determining an access path for each of the at least one first microservice based on the first tenant information; and
forwarding, based on the access path for each of the at least one first microservice, the service request to the at least one first microservice respectively to invoke the at least one first microservice.

4. The method according to claim 1, wherein the service request further carries user credential information; and
the method further comprises:
performing, in response to receiving the service request, an access authentication on the user credential information to obtain an authentication result; and
in a case that the authentication result indicates a successful authentication, determining the first tenant information of the first tenant from the tenant table based on the tenant identification.

5. The method according to claim 4, further comprising:
performing, in response to receiving a user login request from the first tenant, a login verification on user information carried in the user login request to obtain a verification result;
in a case that the verification result indicates a successful login verification, generating the user credential information based on the user information; and
returning the user credential information to the first tenant.

6. The method according to claim 1, further comprising:
creating, in response to a tenant creation request for a second tenant, a second tenant space in the database based on second tenant information carried in the tenant creation request.

7. The method according to claim 6, wherein the creating, in response to a tenant creation request for a second tenant, a second tenant space in the database based on second tenant information carried in the tenant creation request comprises:
generating, in response to the tenant creation request, a random string of a preset length;
generating an initial tenant space in the database by using the random string as a schema space name;
creating a plurality of initial data tables in the initial tenant space based on the second tenant information; and
initializing the plurality of initial data tables using a plurality of data tables comprised in the public space of the database to obtain the second tenant space.

8. The method according to claim 7, wherein the creating a plurality of initial data tables in the initial tenant space based on the second tenant information comprises:
determining at least one second microservice associated with the second tenant based on the second tenant information; and
creating the plurality of initial data tables in the initial tenant space based on a data table associated with each of the at least one second microservice.

9. The method according to claim 7, wherein the initializing the plurality of initial data tables using a plurality of data tables comprised in the public space of the database to obtain the second tenant space comprises:
determining a plurality of target data tables from the plurality of data tables comprised in the public space of the database based on the plurality of initial data tables, wherein the plurality of target data tables correspond to the plurality of initial data tables respectively; and
performing a data synchronization on the plurality of initial data tables using the plurality of target data tables to initialize the plurality of initial data tables, so as to obtain the second tenant space.

10. (canceled)

11. An electronic device comprising a memory and a processor, wherein the memory stores instructions executable by the processor, and when executed by the processor, the instructions cause the processor to execute the method according to claim 1.

12. A non-transitory computer-readable storage medium storing computer instructions, wherein the computer instructions are configured to cause the computer to execute the method according to claim 1.

13. (canceled)

14. The electronic device according to claim 11, wherein the processor is further configured for:
concatenating, in response to acquiring the data change instruction, the first tenant information with the data change instruction to obtain a target data change instruction;
determining the first tenant space from the database based on a space name comprised in the first tenant information; and
executing the target data change instruction to perform the data processing on the data table in the first tenant space.

15. The electronic device according to claim 11, wherein the processor is further configured for:
determining an access path for each of the at least one first microservice based on the first tenant information; and
forwarding, based on the access path for each of the at least one first microservice, the service request to the at least one first microservice respectively to invoke the at least one first microservice.

16. The electronic device according to claim 11, wherein the service request further carries user credential information; and
the processor is further configured for:
performing, in response to receiving the service request, an access authentication on the user credential information to obtain an authentication result; and
in a case that the authentication result indicates a successful authentication, determining the first tenant information of the first tenant from the tenant table based on the tenant identification.

17. The electronic device according to claim 16, wherein the processor is further configured for:
performing, in response to receiving a user login request from the first tenant, a login verification on user information carried in the user login request to obtain a verification result;
in a case that the verification result indicates a successful login verification, generating the user credential information based on the user information; and
returning the user credential information to the first tenant.

18. The electronic device according to claim 11, wherein the processor is further configured for:
creating, in response to a tenant creation request for a second tenant, a second tenant space in the database based on second tenant information carried in the tenant creation request.

19. The electronic device according to claim 18, wherein the processor is further configured for:
generating, in response to the tenant creation request, a random string of a preset length;
generating an initial tenant space in the database by using the random string as a schema space name;
creating a plurality of initial data tables in the initial tenant space based on the second tenant information; and
initializing the plurality of initial data tables using a plurality of data tables comprised in the public space of the database to obtain the second tenant space.

20. The electronic device according to claim 19, wherein the processor is further configured for:
determining at least one second microservice associated with the second tenant based on the second tenant information; and
creating the plurality of initial data tables in the initial tenant space based on a data table associated with each of the at least one second microservice.

21. The electronic device according to claim 19, wherein the processor is further configured for:
determining a plurality of target data tables from the plurality of data tables comprised in the public space of the database based on the plurality of initial data tables, wherein the plurality of target data tables correspond to the plurality of initial data tables respectively; and
performing a data synchronization on the plurality of initial data tables using the plurality of target data tables to initialize the plurality of initial data tables, so as to obtain the second tenant space.

22. The non-transitory computer-readable storage medium according to claim 12, wherein the computer instructions are further configured to cause the computer to:
concatenate, in response to acquiring the data change instruction, the first tenant information with the data change instruction to obtain a target data change instruction;
determine the first tenant space from the database based on a space name comprised in the first tenant information; and
execute the target data change instruction to perform the data processing on the data table in the first tenant space.
